(19) United States
(12) Patent Application Publication
(10) Pub. No.: US 2011/0247035 A1
(43) Pub. Date: Oct. 6, 2011

(54) CONTENT PLAYLIST

(75) Inventors: Venkata S. Adimatyam, Irving, TX (US); Sameer Vasant Gavade, Irving, TX (US)

(73) Assignee: VERIZON PATENT AND LICENSING, INC., Basking Ridge, NJ (US)

(21) Appl. No.: 12/750,937

(22) Filed: Mar. 31, 2010

(51) Int. Cl. H04N 5/445; H04N 7/173

(52) U.S. Cl. 725/39; 725/87

(57) ABSTRACT

A method may include receiving a request to add a video-on-demand (VOD) program selected by a user from a VOD catalog to a playlist. The play list may list a plurality of programs, wherein at least one of the plurality of programs is associated with the VOD catalog and at least one of the plurality of programs is associated with a program guide of scheduled programs. The method may further include adding an indication of the selected VOD program to the playlist and displaying the playlist including the indication of the selected VOD program to the user.

### BACKGROUND INFORMATION

Television viewers have access to an ever-growing amount and variety of content. For example, a viewer may choose between broadcast television programs, pay-per-view programs, on-demand programs, interactive games, or music. The large amount of content can make it difficult for the viewer to find and select desired content. Some content providers offer on-screen program guides or catalogs to assist viewers in finding content.

### BRIEF DESCRIPTION OF THE DRAWINGS

FIG. 1 is a diagram of an overview of an exemplary embodiment described herein;

FIG. 2 is a diagram of an exemplary network for implementing embodiments described herein;

FIG. 3 is a block diagram of exemplary components of a computing module;

FIG. 4 is a block diagram of exemplary components of the playlist server of FIG. 2;

FIG. 5 is a block diagram of exemplary components of the set-top-box of FIG. 2;

FIG. 6 is a diagram of an exemplary playlist table;

FIG. 7A is a diagram of an exemplary video-on-demand rule table;

FIG. 7B is a diagram of an exemplary digital video recorder rule table;

FIG. 7C is a diagram of an exemplary search rule table;

FIGS. 8A and 8B are flowcharts of processes for discovering content and creating playlists of content;

FIG. 9 is a diagram of an exemplary user interface for searching content;

FIG. 10 is a diagram of an exemplary user interface for displaying notifications;

FIGS. 11 and 12 are diagrams of exemplary user interfaces for discovering content;

FIGS. 13 and 14 are diagrams of exemplary user interfaces for presenting playlists to a user.

### DETAILED DESCRIPTION OF PREFERRED EMBODIMENTS

The following detailed description refers to the accompanying drawings. The same reference numbers in different drawings may identify the same or similar elements. Also, the following detailed description is exemplary and explanatory only and is not restrictive of the invention, as claimed.

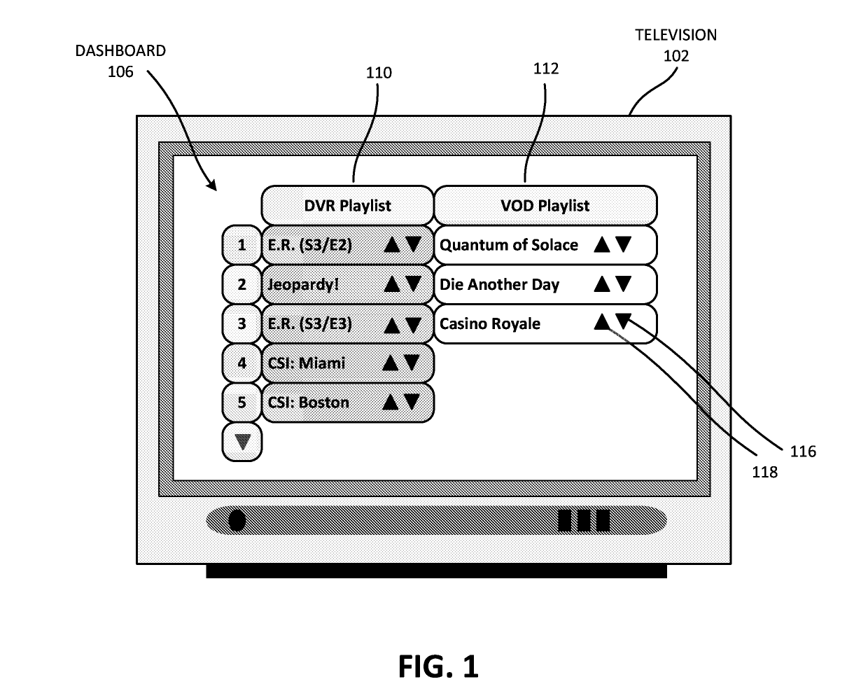

Typical on-screen program guides and catalogs may help viewers find content, but as the amount of content continues to expand, these on-screen program guides and catalogs are inadequate. One or more embodiments disclosed herein allow for users to search for and select programs from a video-on-demand catalog or a program guide for adding to one or more playlists. FIG. 1 is a diagram of an overview of an exemplary embodiment. The embodiment of FIG. 1 includes a television (TV) 102 in a customer's home. TV 102 includes a display that displays a dashboard 106 that lists content a user has added to his or her playlist.

Exemplary dashboard 106 may include a playlist 110 for content associated with (e.g., recorded from) a digital video recorder (DVR) and/or a playlist 112 for content associated with (e.g., available from) a video-on-demand (VOD) server. In one embodiment described below, DVR playlist 110 and VOD playlist 112 may be displayed as a single playlist. In another embodiment, a user may select a graphical widget 116 or 118 to change the position of a program in the playlist.

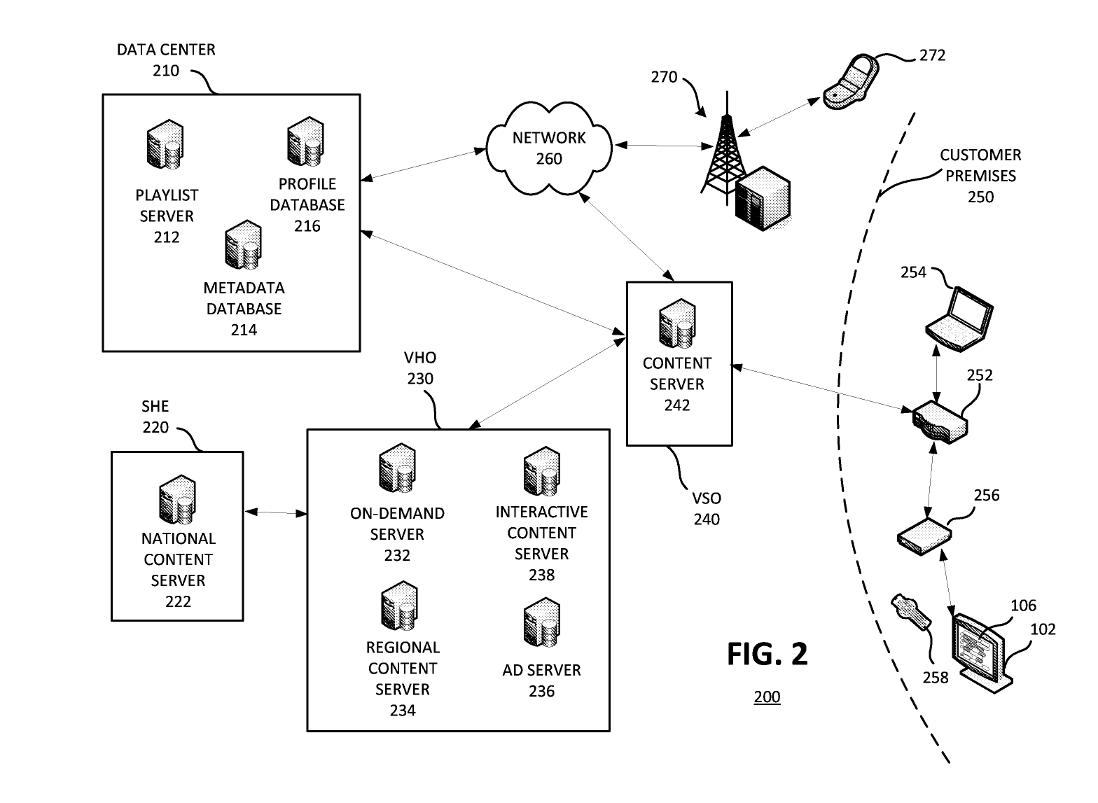

FIG. 2 is a diagram of an exemplary network 200 for implementing embodiments described herein. Network 200 may include a data center 210, a super head end (SHE) 220, a video hub office (VHO) 230, a video service office (VSO) 240, customer premises 250, a network 260, a base station system (BSS) 270, and a mobile device 272.

As with FIG. 1, customer premises 250 (e.g., the customer's home) includes TV 102 with a display showing dashboard 106. Customer premises 250 may also include an optical network terminal (ONT) 252, a set-top box (STB) 256, a computer 254, and a remote control 258. ONT 252 may receive data, e.g., on a fiber optic cable, and may transfer the data to the appropriate device in customer premises 250, such as a telephone (not shown), computer 254, or STB 256. Likewise, ONT 252 may receive data from any device in customer premises 250 and may transmit the data to other devices in network 200, e.g., through a fiber optic cable.

STB 256 may receive content through content server 242, for example, and output the content to TV 102 for display. In one embodiment STB 256 may include the functionality of a DVR for time-shifting recorded content. STB 256 may include a component (e.g., a cable card or a software package) that plugs into a host device (e.g., a DVR, a personal computer, television 102, a stereo system, etc.) that allows the host device to display content. STB 256 may also be implemented as a home theater personal computer (HTPC), an optical disk player (e.g., digital video disk (DVD) or Blu-Ray™ disc player), a cable card, etc. STB 256 may receive commands from other components in network 200 (e.g., remote control 258).

Remote control 258 may issue wired or wireless commands for controlling other electronic devices, such as TV 102 or STB 256. Remote control 258, in conjunction with STB 256, may allow a user to manually select programs for viewing on TV 102. In one embodiment, remote control 258 may be used in conjunction with STB 256 to discover content, add content to a playlist, and watch content listed in a playlist (e.g., dashboard 106). Other types of devices (e.g., a keyboard, mouse, a mobile phone, etc.) may be used instead of remote control 258.

TV 102 may include speakers as well as a display. TV 102 may play content, for example, received through VSO 240 or from a DVR (e.g., a DVR in STB 256). While some disclosed embodiment may use TV 102, other embodiments may play content using any device (e.g., computer 254 or mobile phone 272) capable of receiving and displaying content, for example.

Customer premises 250 may connect to VSO 240. VSO 240 may collect and deliver content (e.g., dashboard 106 and selected programs) to customer premises 250 and may receive data from customer premises 250 for forwarding to the proper destination (e.g., network 260, or any device in network 200). VSO 240 may include a content server 242. Content server 242 may include a content mixing engine (e.g., a multiplexer/demultiplexer) to select information, such as on-demand content, regional and national video content, interactive content, and/or advertising content, and mix the information together. Content server 242 may also perform transcoding of the mixed information and/or encoding or encryption functions.

Data center 210 may include components that manage and/or store information associated with providing a dashboard and/or play lists. As shown in FIG. 2, data center 210 may include a playlist server 212, a metadata database 214, and a profile database 216.

Metadata database 214 may include a server that stores information about content. For a movie, for example, metadata database 214 may store the title, genre, plot, director, cast, etc., of the video. Metadata database 214 may also store information about content other than videos, such as interactive games or music. As used herein, the term “program” or “content” may refer to any type of content, such as TV programs, movies, interactive games, audio, radio, etc. Playlist server 212 may use metadata database 214, a program guide, and/or a VOD catalog to search for content and add content to playlists.

Profile database 216 may include a server that stores information about preferences of a user or a group of users, or other information to determine such preferences. For example, profile database 216 may include metadata associated with programs in a playlist and associated with a profile.

Playlist server 212 may use metadata database 214, profile database 216, a VOD catalog, and/or a program guide to discover content on behalf of a user or group of users. Playlist server 212 may add or remove content to or from playlists, may generate a dashboard for displaying playlists (e.g., dashboard 106), and may organize playlists on behalf of users.

SHE 220 may include a national content server 222. National content server 222 may include a source of for-pay television broadcasts (e.g., TNT, ESPN, HBO, Cinemax, CNN, etc.). VHO 230 may include an on-demand server 232, a regional content server 234, an advertisement (ad) server 236, and an interactive content server 238. Regional content server 234 may provide television broadcasts (e.g., local broadcasts, such as NBC, CBS, ABC, Fox, local cable access channels, etc.). On-demand server 232 may provide on-demand content. Ad server 236 may provide and/or manage the advertising content (e.g., commercials) that is presented with other content. Interactive content server 238 may serve and manage interactive content (e.g., a form of content with which a user can interact). For example, interactive content may include an interactive playlist (e.g., dashboard 106), an interactive game, or interactive advertisements.

Network 260 may include one or more packet switched networks, such as an Internet protocol (IP) based network, a local area network (LAN), a wide area network (WAN), a personal area network (PAN), an intranet, the Internet, or another type of network that is capable of transmitting data. Network 260 may include a circuit-switched network, such as a public-switched telephone network (PSTN) for providing telephone services for traditional telephones. Network 260, in conjunction with components in VSO 240, may allow devices at customer premises 250 (e.g., a computer or a set-top box) to connect to other devices also attached to network 260, such as third party web site servers (not shown) or other customers (not shown).

BSS 270 may control traffic and signaling with a mobile device. BSS 270 may include an antenna to transmit and receive signals to and from a mobile device, such as mobile device 272. Mobile device 272 may include a radiotelephone, a personal communications system (PCS) terminal, a personal digital assistant (PDA), a laptop, or another portable communication device. In one embodiment, mobile device 272 may be able to receive short message service (SMS) messages that notify the user of mobile device 272 of new programs added to a playlist, of programs that have become available for adding to a playlist, etc.

The exemplary configuration of devices in network 200 is illustrated for simplicity. Network 200 may include more devices, fewer devices, or a different configuration of devices than illustrated in FIG. 2. For example, network 200 may include thousands or millions of customer homes. In some embodiments, the functions performed by two or more devices may be performed by any one device. Likewise, in some embodiments, the functions performed by any one device may be performed multiple devices. Further, the connections shown in FIG. 2 are exemplary. In other embodiments, additional connections that are not shown in FIG. 2 may exist between devices (e.g., each device may be connected to every other device). The connections in FIG. 2 may also be wireless or wired.

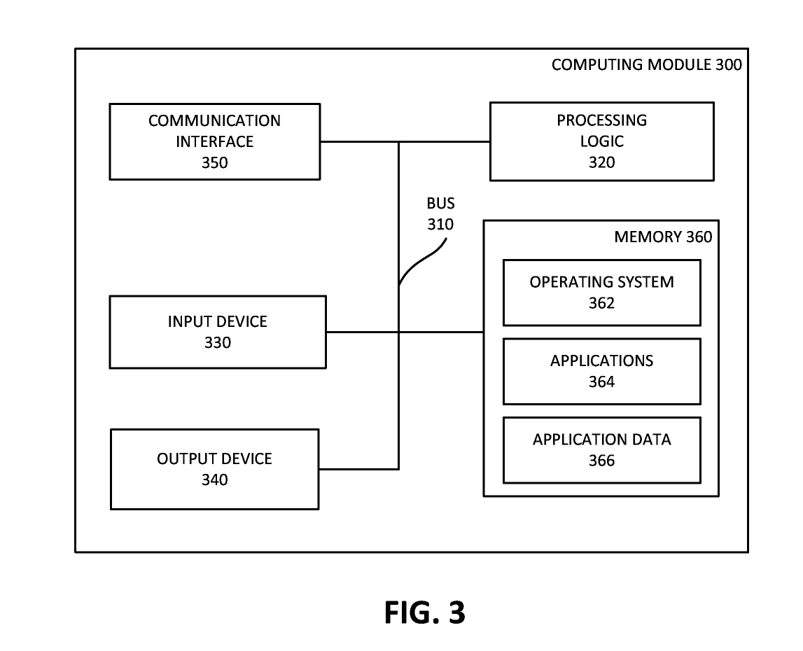

Devices in network 200 may include one or more computing modules. FIG. 3 is a block diagram of exemplary components of a computing module 300. Computing module 300 may include a bus 310, processing logic 320, an input device 330, an output device 340, a communication interface 350, and a memory 360. Computing module 300 may include other components (not shown) that aid in receiving, transmitting, and/or processing data. Moreover, other configurations of components in computing module 300 are possible.

Bus 310 may include a path that permits communication among the components of computing module 300. Processing logic 320 may include any type of processor or microprocessor (or families of processors or microprocessors) that interprets and executes instructions. In other embodiments, processing logic 320 may include an application-specific integrated circuit (ASIC), a field-programmable gate array (FPGA), or the like.

Input device 330 may allow a user to input information into computing module 300. Input device 330 may include a keyboard, a mouse, a pen, a microphone, a remote control (e.g., remote control 258), a touch-screen display, etc. Some devices, such servers 232-238 may be managed remotely and may not include input device 330. In other words, some devices may be “headless” and may not include a keyboard, for example.

Output device 340 may output information to the user. Output device 340 may include a display, a printer, a speaker, etc. For example, TV 102 includes a display (an output device), which may include a liquid-crystal display (LCD) for displaying content to the user. As another example, ONT 252 and STB 256 may include light-emitting diodes (LEDs). Headless devices, such as servers 212-242, may be managed remotely and may not include a display, for example.

Input device 330 and output device 340 may allow the user to activate and interact with a particular service or application, such as a playlist (e.g., dashboard 106). Input device 330 and output device 340 may allow the user to receive and view a menu of options and select from the menu options. The menu may allow the user to select various functions or services associated with applications executed by computing module 300.

Communication interface 350 may include a transceiver that enables computing module 300 to communicate with other devices and/or systems. Communication interface 350 may include a transmitter that may convert baseband signals to radio frequency (RF) signals and/or a receiver that may convert RF signals to baseband signals. Communication interface 350 may be coupled to an antenna for transmitting and receiving RF signals. Communication interface 350 may include a network interface card, e.g., Ethernet card, for wired communications or a wireless network interface (e.g., a WiFi) card for wireless communications. Communication interface 350 may also include, for example, a universal serial bus (USB) port for communications over a cable, a Bluetooth™ wireless interface, an RFID interface, a near-field communications (NFC) wireless interface, etc.

Memory 360 may store, among other things, information and instructions (e.g., applications 364 and operating system (OS) 362) and data (e.g., application data 366) for use by processing logic 320. Memory 360 may include a random access memory (RAM) or another type of dynamic storage device; a read-only memory (ROM) device or another type of static storage device; and/or some other type of magnetic or optical recording medium and its corresponding drive (e.g., a hard disk drive (HDD)).

OS 362 may include software instructions for managing hardware and software resources of computing module 300. For example, OS 362 may include Linux, Windows, OS X, an embedded operating system, etc. Applications 364 and application data 366 may provide network services or include applications, depending on the device in which the particular computing module 300 is found.

Computing module 300 may perform the operations described herein in response to processing logic 320 executing software instructions contained in a computer-readable medium, such as memory 360. A computer-readable medium include a physical or logical memory device. The software instructions may be read into memory 360 from another computer-readable medium or from another device via communication interface 350. The software instructions contained in memory 360 may cause processing logic 320 to perform processes that are described herein.

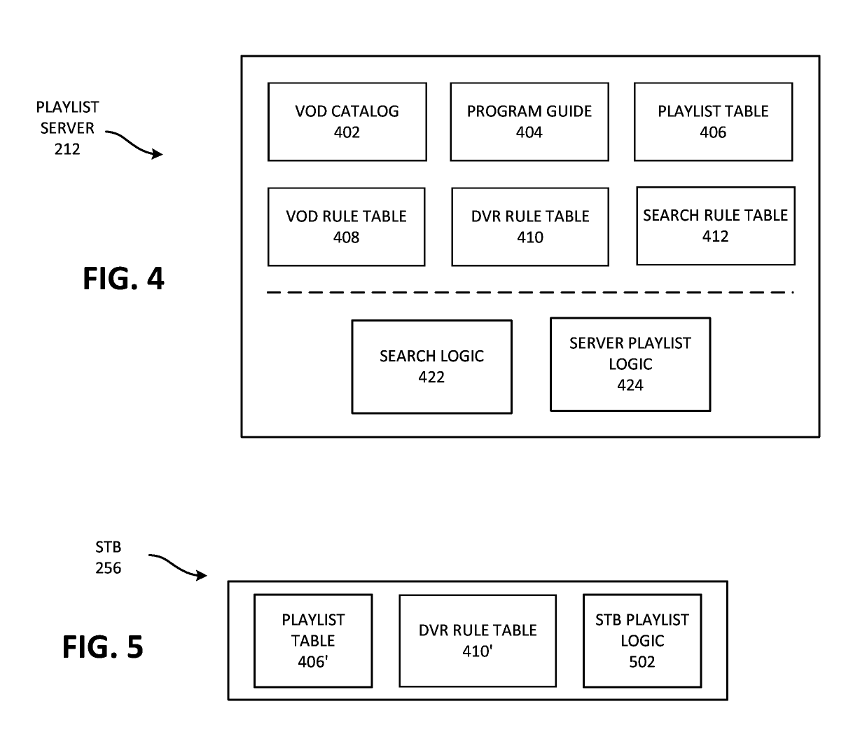

As discussed above, playlist server 212 may use a metadata database, a VOD catalog, and a program guide to discover content for adding to playlists at the request of a user. FIG. 4 is a block diagram of exemplary components of playlist server 212 (e.g., functions performed by application 364 in processing logic 320 or stored in memory 360 of playlist server 212). Playlist server 212 may store a video-on-demand (VOD) catalog 402, a program guide 404, a playlist table 406, a VOD rule table 408, a DVR rule table 410, and a search rule table 412. Playlist server 212 may also include search logic 422 and server playlist logic 424. Some components shown in FIG. 4 may also be stored in other devices in network 200, for example.

VOD catalog 402 may identify content stored in on-demand server 232, for example, for delivery to STB 256. VOD catalog 402 may also or alternatively be stored in on-demand server 232. Program guide 404 may identify the content (e.g., scheduled content), broadcast times, and channels associated with content, such as content stored in regional content server 234 or national content server 222.

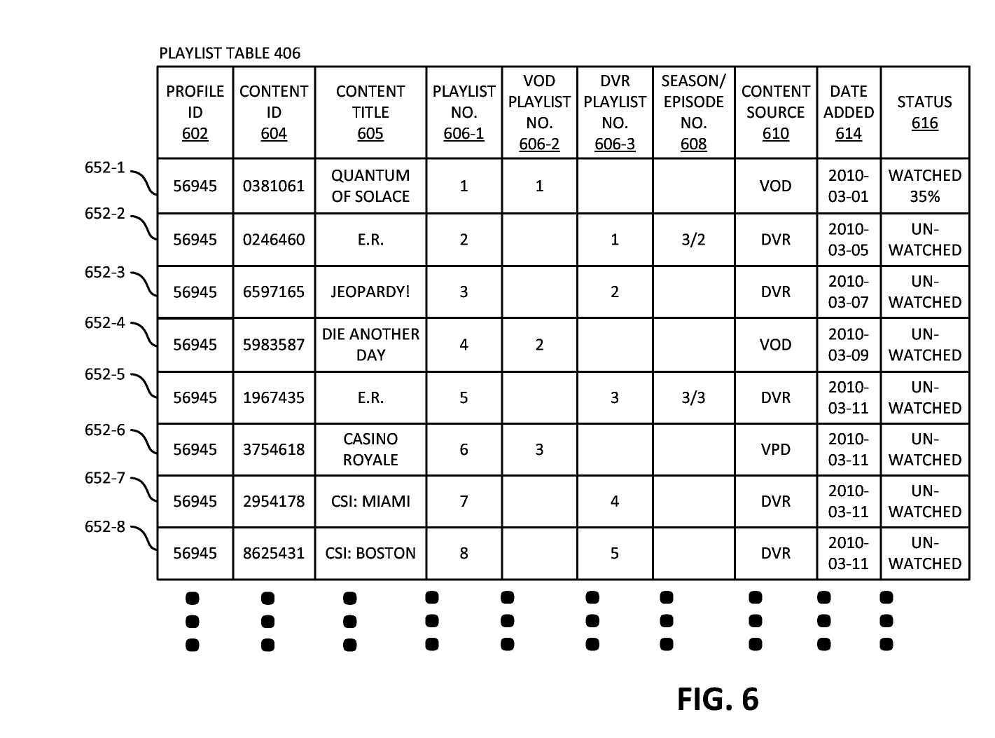

Playlist table 406 may store information regarding playlists associated with a user profile, for example. FIG. 6 is a diagram of an exemplary playlist table 406. Records (e.g., entries) 652 in playlist table 406 may define the position of a piece of content in a playlist for a particular user (e.g., profile ID). Playlist table 406 may include a profile ID field 602, a content ID field 604, a content title field 605, a playlist number field 606-1, a VOD playlist number field 606-2, a DVR playlist number field 606-3, a season/episode number field 608, a content source field 610, a date added field 614, and a status field 616.

Profile ID field 602 may include a value (e.g., a unique value) identifying a profile for storing a playlist. For example, records 652 in exemplary playlist table 406 include a profile ID of 56945 in profile ID field 602. Thus, exemplary playlist table 406 stores information regarding the playlist associated with one profile. Other implementations may store information for more than one profile.

Content ID field 604 may include a value (e.g., a unique value) identifying a piece of content stored in a content server, such content servers 222-238, or STB 256. Record 652-1 of playlist table 406, for example, includes a value of 0381061 in content ID field 604. Content title field 605 may identify the title of the corresponding content. For example, the content identified by the ID 0381061 is “Quantum of Solace.”

Playlist number field 606-1 may indicate the location of the corresponding content in a playlist (e.g., a combined playlist) relative to other content in the playlist for the corresponding profile. VOD playlist number field 606-2 may indicate the location of the corresponding VOD content in a VOD playlist relative to other VOD content for the corresponding profile. DVR playlist number field 606-3 may indicate the location of the corresponding DVR content in a DVR playlist relative to other DVR content for the corresponding profile.

Season/Episode number field 608 may indicate whether the corresponding content is part of a series of programs and, if so, the season and the episode number of the program. In one embodiment, season/episode number field 608 may indicate the number of the program in a series of programs (e.g., the sequence number of a series of movies related to each other).

Content source field 610 may include information indicating the source of the corresponding content. For example, content source field 610 may include the value “DVR” for content recorded by the DVR and stored in STB 256. Date added field 614 may indicate the date that the content was added to the playlist table 406.

Status field 616 may indicate whether the corresponding content has been watched or not. In one embodiment, if the corresponding program has been watched, status field 616 may indicate whether the program has been partially watched (e.g., 35%).

Playlist table 406 may include additional, different, or fewer fields than illustrated in FIG. 6. For example, playlist table 406 may include a broadcast field indicating when a program was first broadcast. As another example, playlist table 406 may include an availability date field indicating when the content (e.g., VOD content) first became available to users.

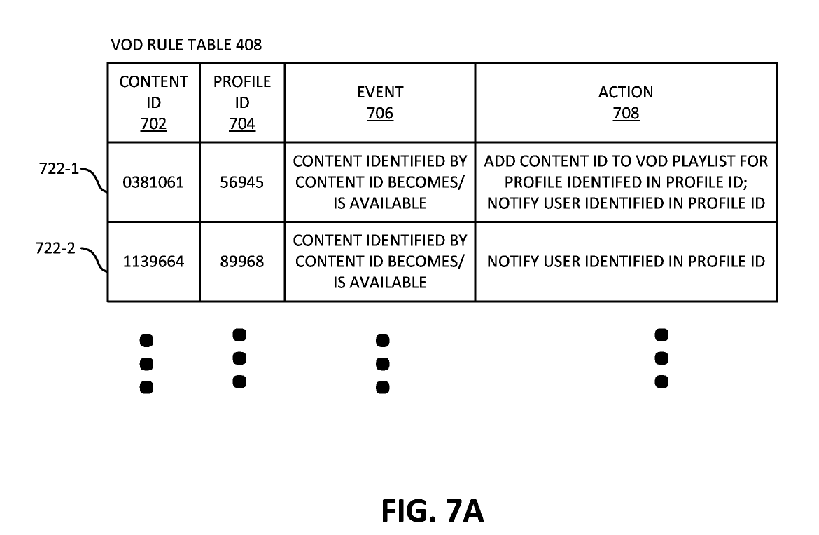

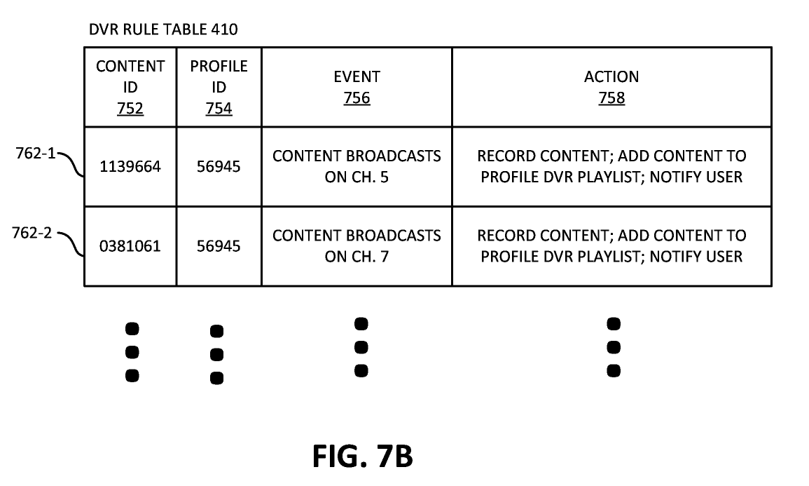

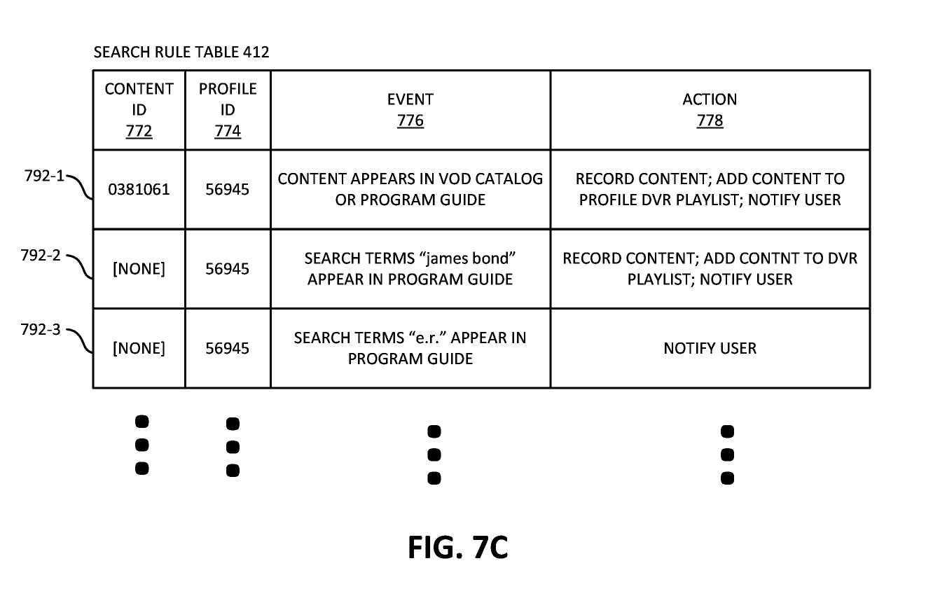

Returning to FIG. 4, VOD rule table 408 may store information (e.g., rules) related to adding content to VOD playlists when content becomes available (e.g., when the content is currently available as opposed to “coming soon”). FIG. 7A is a diagram of an exemplary VOD rule table 408. Records 722 in VOD rule table 408 may each be associated with a rule for a particular piece of content (e.g., a content ID) and a particular user or group of users (e.g., a profile ID). VOD rule table 408 may include a content ID field 702, a profile ID field 704, an event field 706, and an action field 708. VOD rule table 408 may include additional, different, or fewer fields than illustrated in FIG. 7A.

Content ID field 702 may include a value (e.g., a unique value) identifying a piece of content to which the corresponding rule applies. For example, record 722-1 of VOD rule table 408 specifies a value of 0381061 in content ID field 702. Thus, record 722-1 stores a rule associated with that content. As shown, other records include different values in content ID field 702.

Profile ID field 702 may include a value (e.g., a unique value) identifying a profile for which the corresponding rule applies. For example, record 722-1 in exemplary VOD rule table 408 include a profile ID of 56945 in profile ID field 702. Thus, record 722-1 stores a rule associated with that profile. As shown, other records include different profile IDs in profile ID field 704 (e.g., the action taken and the event).

Event field 706 includes the conditions to be met for executing an action in action field 708. For example, record 722-1 includes an event of “content identified by content ID becomes/is available.” Action field 708 may specify the action to take when the conditions in event field 706 have been met. For example, record 722-1 indicates adding the content ID (e.g. specified in content ID field 702) to the VOD playlist for the profile identified in profile ID field 704. In this example, record 722-1 also specifies notifying the user identified in profile ID field 704.

Returning to FIG. 4, DVR rule table 410 may store information (e.g., rules) related to adding content to a DVR playlist. FIG. 7B is a diagram of an exemplary DVR rule table 410. Records 762 in DVR rule table 410 may be associated with a rule for a particular piece of content (e.g., a content ID) and a particular user (e.g., a profile ID). DVR rule table 410 may include a content ID field 752, a profile ID field 754, an event field 756, and an action field 758.

Content ID field 752, profile ID field 754, event field 756, and action field 758 may include information similar to content ID field 702, profile ID field 704, event field 706, and action field 708 of VOD rule table 408 discussed above with respect to FIG. 7A. DVR rule table 410, however, may relate to scheduled programs recorded by a DVR, for example. Record 762-1 specifies (in event field 756) that when the content identified in content ID field 752 is broadcast on channel 5, then actions (specified in action field 758) include recording the content, adding the content to the DVR playlist associated with the profile, and notifying the user associated with the profile ID in profile ID field 754.

Returning to FIG. 4, search rule table 412 may store information (e.g., rules) related to discovering content for adding to a playlist. FIG. 7C is a diagram of an exemplary search rule table 412. Records 792 in search rule table 412 may be associated with a rule associated with particular piece of content (e.g., a content ID), a particular user (e.g., a profile ID), and/or search terms, for example. Search rule table 412 may include a content ID field 772, a profile ID field 774, an event field 776, and an action field 778.

Content ID field 772, profile ID field 774, event field 776, and action field 778 may include information similar to content ID fields 702 and 752, profile ID fields 704 and 754, event fields 706 and 756, and action fields 708 and 758 of VOD rule table 408 and DVR rule table 752 discussed above with respect to FIGS. 7A and 7B. Search rule table 412, however, may relate to content or content matching search terms not yet discovered in VOD catalog 402 and/or program catalog 404, for example. Record 792-1 of search rule table 412, for example, specifies (in event field 776) that when the content identified in content ID field 772 appears in a search of VOD catalog 402 or program guide 404, then actions taken (specified in action field 778) may include recording the content, adding the content to the DVR/VOD playlist associated with the profile identified in profile ID field 774, and notifying the user associated with the profile identified in profile ID field 754.

As another example, record 792-2 does not specify a content ID in field 772. Rather, event field 776 specifies that when the content that matches the terms “james bond” appears in VOD catalog 402 or program guide 404, then actions taken (specified in action field 778) may include recording the content, adding an indication of the content to the DVR/VOD playlist associated with the profile identified in profile ID field 774, and notifying the user associated with the profile identified in profile ID field 754.

Returning to FIG. 4, playlist server 212 may store search logic 422 and server playlist logic 424. Search logic 422 may search VOD catalog 402, program guide 404, and other metadata for content at the behest of a user. Server playlist logic 424 may add content (e.g., content found using search logic 422) to playlists associated with users or groups of users (e.g., profiles). Playlist server 212 may store more, fewer, or different components than shown in FIG. 4. For example, playlist server may store a profile table for recording the preferences of users and groups of users. As another example, playlist server 212 may store a metadata table having information about content (e.g., content provided by content servers 222-238), such as the title, genre, plot, cast, etc., of the content. Such a metadata table 406 may also be stored in metadata database 214 and retrieved by playlist server 212 from metadata database 214.

FIG. 5 is a block diagram of exemplary components of STB 256 (e.g., functions performed by application 364 by processing logic 320 or stored in memory 360 of STB 256). STB 256 may include playlist 406′ (e.g., a subset of playlist 406 stored in playlist server 212), DVR rule table 410′ (e.g., a subset of DVR rule table 410 stored in playlist server 212), and STB playlist logic 502. STB 256 may include additional or fewer components than shown in FIG. 5. Further, other devices in network 200 may include the components shown in FIG. 5, such as mobile phone 272, computer 254, or TV 102.

STB playlist logic 502 may identify the users watching TV 102, for example, and their associated profiles so that STB profile logic 502 may display the appropriate playlists (e.g., dashboard 106). STB playlist logic 502 may identify users and profiles, for example, by using biometric methods or sensing devices carried or worn by users. As yet another example, STB playlist logic 502 may identify users and profiles by virtue of a user “logging in” to an account associated with a profile. STB playlist logic 502 may allow a user to discover content (e.g., search or browse) for adding to a playlist. STB playlist logic 502 may allow a user to edit and organize playlists. STB playlist logic 502 may interact with server playlist logic 424 (in playlist server 212) to discover and store playlists for a user or a group of users.

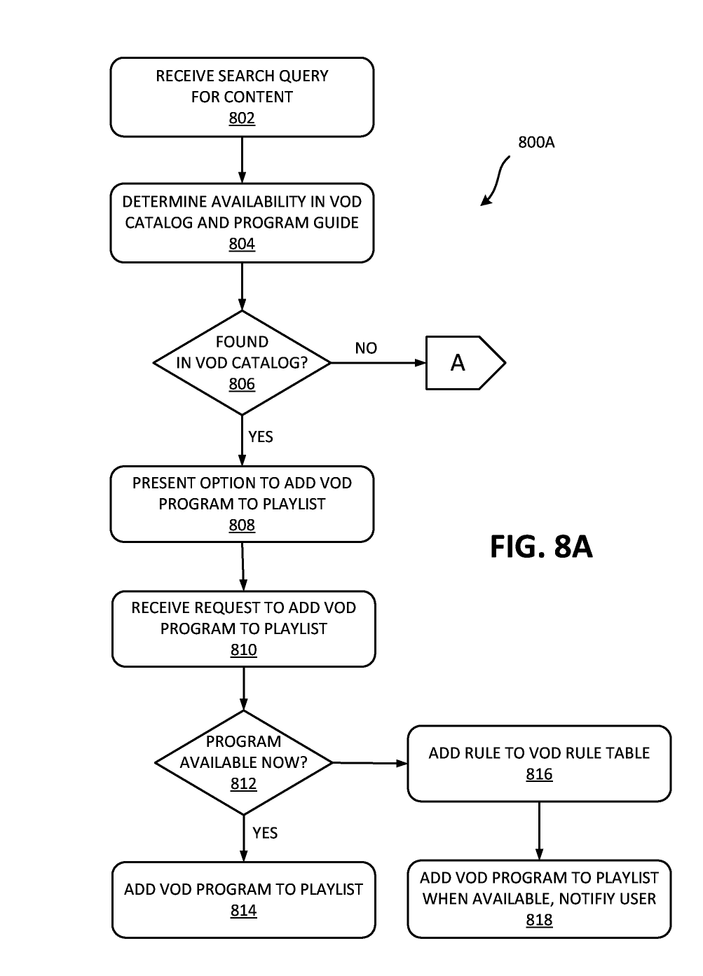

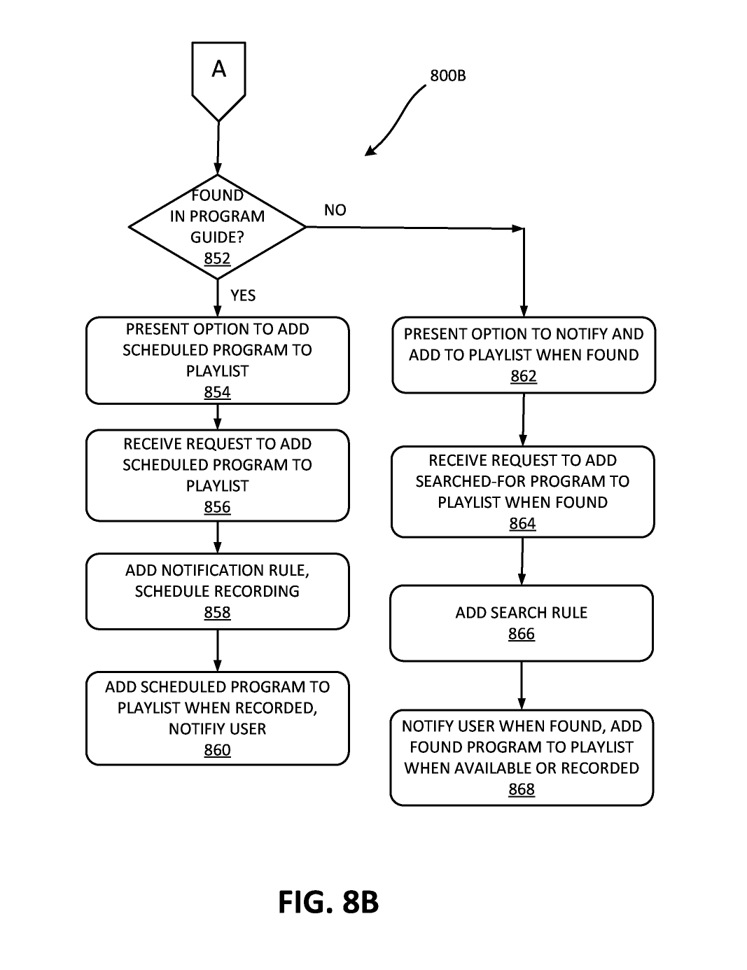

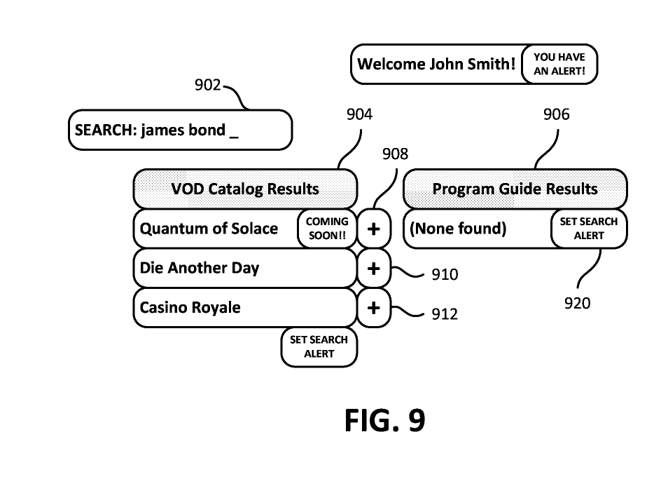

FIGS. 8A and 8B are flowcharts of processes 800A and 800B for discovering content and creating playlists. Process 800A may begin when a user sits in front of TV 102 and searches for content (e.g., using remote 258). The user may enter a search query for content. The search query for the content may be received (block 802) in STB 256, for example, from the user. Further, the search query may be sent to and received in playlist server 212. In another embodiment, the search query may be received from computer 254 from a user interacting with a keyboard, for example. FIG. 9 is a diagram of an exemplary user interface 900 for a user to enter a search query. As shown in FIG. 9, the user enters the search query “james bond” into search box 902. The search query for “james bond” may be received by, for example, STB 256 and/or playlist server 212.

The availability of the searched-for content in a VOD catalog and/or a program guide may be determined (block 804). For example, playlist server 212 may search for “james bond” in VOD catalog 402 and associated metadata tables (e.g., retrieved from metadata database 214 and/or on-demand server 232). As shown in FIG. 9, a search for “james bond” may result in a list 904 of James Bond movies (e.g., “Quantum of Solace,” “Die Another Day,” and “Casino Royale.” In the current example, list 904 indicates that “Quantum of Solace” is not yet available, but is coming soon. Playlist server 212 may also search for “james bond” in program guide 404 and associated metadata tables (e.g., retrieved from metadata database 214, national content server 222, and/or regional content server 234). As shown in FIG. 9, a list 906 of program guide results for the search may result in no currently scheduled programs.

If the searched-for content is found in a VOD catalog (block 806: YES), then an option to add the found VOD program to a playlist (e.g., a VOD playlist) may be provided. For example, as shown in FIG. 9, plus (“+”) widgets 908, 910, and 912 may be presented to the user indicating that the user may select content to be added to a playlist. If the user so desires, the user may request that a VOD program be added to a playlist by selecting widget 908 using, for example, remote 258. The request to add the found VOD program may be received (block 808) by, for example, STB 256 from remote 258. In one embodiment, the selection may be sent to and received by playlist server 212.

If the found VOD program is currently available (block 812: YES), then the found VOD program may be added to a playlist (block 814). For example, as shown in FIG. 9, the content titled “Die Another Day” and the content titled “Casino Royale” are currently available, while the content titled “Quantum of Solace” is not currently available (i.e., it is “coming soon”). If the user selects widget 910 or 912, then the corresponding VOD programs may be added to a playlist. For example, selection of widget 910 (for “Die Another Day”) may result in the addition of record 652-4 to playlist table 406.

If a VOD program is found, but not currently available (block 812: NO), then a rule may be added to a rule table (block 816) (e.g., VOD rule table 408) for when the VOD program becomes available. For example, the content titled “Quantum of Solace” is not currently available, it is “coming soon.” Selection of widget 908 may result in record 722-1 being added to VOD rule table 408. As discussed above, the rule in record 722-1 will add “Quantum of Solace” (e.g., the content identified by content ID of 0381061) to the VOD playlist (e.g., playlist table 406) associated with the profile identified by the profile ID of 56945 (e.g., John Smith).

When the found VOD program becomes available (e.g., the conditions of the rule added to rule table in block 816 are met), then the found VOD program may be added to the playlist and the user may be notified (block 818). For example, playlist server 212 may continuously or periodically monitor VOD catalog 402 to determine (according to VOD rule 722-1) when “Quantum of Solace” (e.g., content identified by the ID of 0381061) becomes available. When the content becomes available, record 652-1 may be added to playlist table 406.

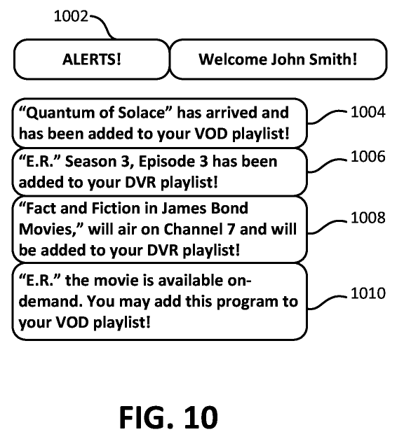

Further, John Smith may be notified (according to record 652-1) of the addition of the content to his VOD playlist. FIG. 10 is diagram of an exemplary user interface for displaying notifications. As shown in FIG. 10, widget 1004 alerts John Smith that “Quantum of Solace” has arrived and has been added to his VOD playlist.

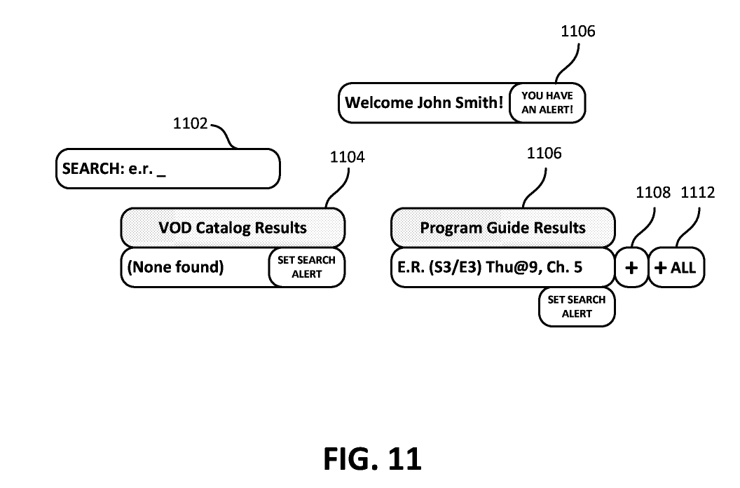

Returning to block 806, if the searched-for content is not found in the VOD catalog (block 806: NO), but the searched-for program is found in the program guide (block 852: YES) (FIG. 8B), then an option to add the found scheduled program to a playlist may be presented (block 854). FIG. 11 is a diagram of an exemplary user interface 1100 for a user to enter a search query. As shown in FIG. 11, the user enters the search query “e.r.” into search box 1102. The search query for “e.r.” may be received by STB 256 and/or playlist server 212, for example. Playlist server 212 may search for “e.r.” in program guide 404 and associated metadata tables (e.g., retrieved from metadata database 214, national content server 222, and/or regional content server 234). As shown in FIG. 11, a search for “e.r.” may result in a list 1106 of upcoming scheduled episodes of “E.R.” (e.g., the third season, third episode of “E.R.” playing Thursday at 9 p.m. on channel 5). Playlist server 212 may also search for “E.R.” in VOD catalog 402 and associated databases (e.g., retrieved from metadata database 214 and/or on-demand server 232). As shown in FIG. 11, a list 1104 of VOD catalog results for the search may result in no currently cataloged programs.

As shown in FIG. 11, a plus (“+”) widget 1108 may be presented to the user indicating that the user may select the corresponding program to be added to a playlist. The user may use remote 258, for example, to select widget 1108 to request that the found scheduled program be added to a playlist. The request to add the scheduled program may be received (block 856) by STB 256 and/or playlist server 212. In one embodiment, if the scheduled program is part of a series (e.g., a TV series), the user may request the addition of subsequent or earlier series programs to the playlist. For example, a “+ALL” widget 1112 may be presented to the user for the user to select if all episodes should be selected.

A rule may be added to DVR rule table (block 858) to schedule a recording, for example. If the user selects widget 1108 to add E.R. to the playlist, for example, then rule 762-1 may be added to DVR rule table 410. As discussed above, when the content identified by the ID of 1139664 (e.g., E.R., season 3, episode 3) is broadcast on channel 5 (as defined in event field 756), then the actions specified in action field 758 may be implemented. Thus, when the scheduled program broadcasts (e.g., the conditions of the rule added to rule table in block 858 are met), then the scheduled program may be recorded, added to the playlist (record 652-5 may be added to playlist table 406), and the user may be notified (block 860). As shown in FIG. 10, for example, notice 1006 may indicate to John Smith that E.R., episode 3 of season 3, has been added to a DVR playlist.

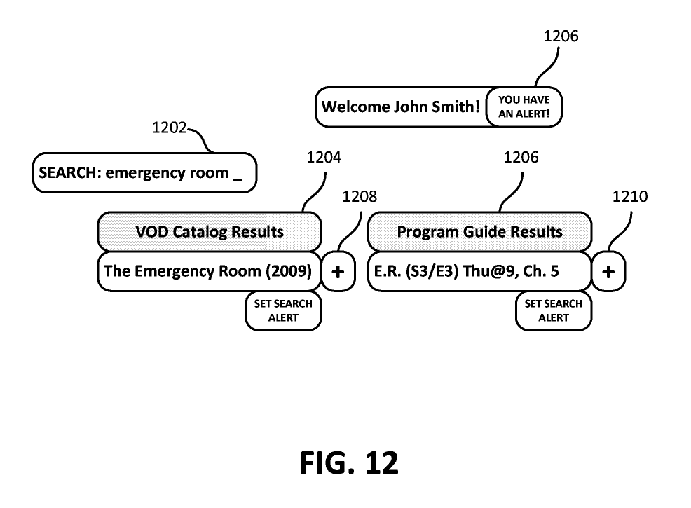

In one embodiment, if the searched-for content appears in both the VOD catalog and the program guide, then the user may select to add content from either search results. For example, FIG. 12 is a diagram of search results from both a VOD catalog and a program guide. In this example, the user may select graphical widget 1208 to add the resulting VOD program in VOD catalog result list 1204 to a playlist, or the user may select widget 1210 to add the resulting scheduled program to the playlist.

If the searched-for program is not found in the VOD catalog (block 806: NO) and/or the program guide (block 852: NO), then the user may be presented with an option to add a notification when the searched-for content is found (block 862). For example, as shown in FIG. 9, the user may select graphical widget 920 to continue searching for the content continuously or on a periodic basis. The user may also be presented with an option to add the searched-for content to a playlist when the searched-for content is found in the VOD catalog and/or the program guide (block 864).

A rule (e.g., a search rule) may be added to a rule table (block 866). For example, record 792-2 in search rule table 412 indicates that when a program appears in the program guide that satisfied the search term “james bond,” then the content should be recorded, added to a DVR playlist, and the user should be notified. When the found scheduled program broadcasts (e.g., the conditions of the rule added to rule table in block 866 are met), then the found scheduled program may be recorded when broadcasted and added to the playlist, and the user may be notified (block 868). Notifications 1008 and 1010 in FIG. 10 are examples of notifications resulting from action taken as indicated in search table 412.

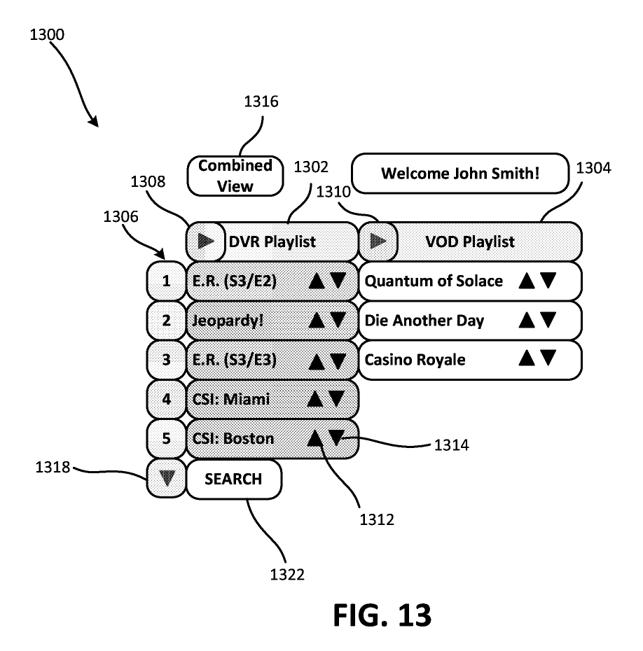

FIG. 13 is a diagram of an exemplary user interface (e.g., a dashboard 1300) for presenting playlists to a user. Dashboard 1300 includes a DVR playlist 1302 for showing recorded content (e.g., cataloged in program guide 404) in an order for viewing. DVR playlist 1302 corresponds to information stored in playlist table 406 (e.g., DVR playlist number field 606-3). The order for content listed in DVR playlist 1302 is indicated by a numbered list 1306. In one embodiment, a user may select to start playing content in DVR playlist 1302 by selecting a start widget 1308.

Dashboard 1300 also includes a VOD playlist 1304 for showing VOD content (e.g., cataloged in VOD catalog 402) in an order for viewing. VOD playlist 1304 corresponds to information stored in playlist table 406 (e.g., DVR playlist number field 606-3). The order for viewing content listed in VOD playlist 1304 is also indicated by numbered list 1306. In one embodiment, a user may select to start playing content in VOD playlist 1304 by selecting a start widget 1310. VOD playlist 1304 corresponds to information stored in playlist table 406 (e.g., VOD playlist number field 606-2).

In one embodiment, the user may move a program up or down in either list 1302 or 1304 by selecting a corresponding up widget 1312 or a corresponding down widget 1314. In another embodiment, a user may select to view a combined playlist by selecting a combined view widget 1316. In yet another embodiment, a user may scroll up or down a playlist by selecting a down widget 1318 or an up widget (now shown). In addition, a user may request to search for content by selecting widget 1322.

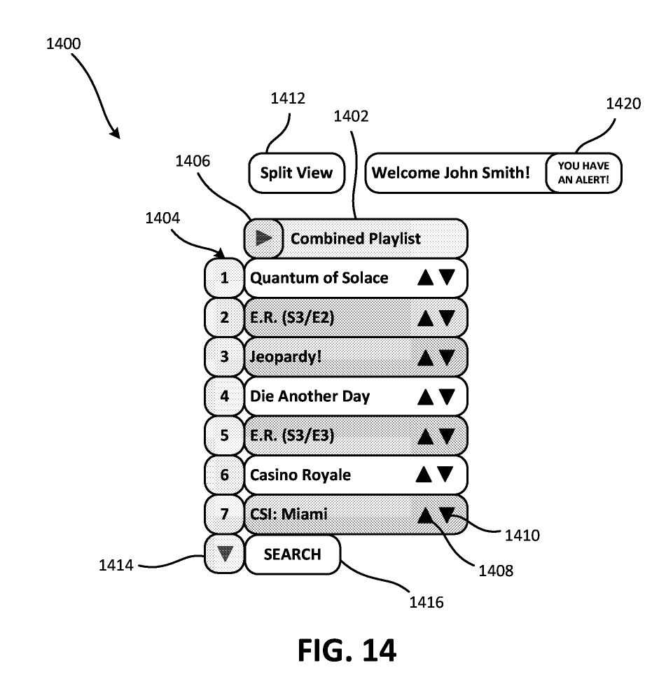

FIG. 14 is a diagram of an exemplary user interface (e.g., a dashboard 1400) for presenting a combined playlist to a user. Dashboard 1400 includes a playlist 1402 that combines DVR playlist 1302 and VOD playlist 1304 in an order for viewing content. Playlist 1402 corresponds to information stored in playlist table 406 (e.g., playlist number field 606-1). The order for viewing content listed in playlist 1402 is indicated by a numbered list 1404. In one embodiment, a user may select to start playing content in playlist 1402 by selecting a start widget 1406. In dashboard 1400, VOD content (e.g., list items 1, 4, and 6) may be a different color than DVR content (e.g., list items 2, 3, 5, and 7).

In one embodiment, the user may move a program up or down in playlist list 1402 by selecting a corresponding up widget 1408 or a corresponding down widget 1410. In another embodiment, a user may select to view a split playlist by selecting a split view widget 1412, which may result in the display of dashboard 1300 shown in FIG. 13. In yet another embodiment, a user may scroll up or down playlist 1402 by selecting a down widget 1414 or an up widget (now shown). In addition, a user may request to search for content by selecting widget 1416. A user may also select to view alerts (e.g., as shown in FIG. 10) by selecting “You have an alert!” widget 1420.

The order of programs in a playlist may (1) according to when the program was added to the playlist (e.g., programs added later are added to the end or beginning of the playlist); (2) according to broadcast, availability, or release date (e.g., programs are listed in chronological order or reverse chronological order); and/or (3) according to episode, season, or sequence number (e.g., earlier seasons, episodes, or sequence numbers appearing earlier).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

While series of blocks have been described above with respect to different processes, the order of the blocks may differ in other implementations. Moreover, non-dependent acts may be performed in parallel.

It will be apparent that aspects of the embodiments, as described above, may be implemented in many different forms of software, firmware, and hardware in the embodiments illustrated in the figures. The actual software code or specialized control hardware used to implement these embodiments is not limiting of the invention. Thus, the operation and behavior of the embodiments of the invention were described without reference to the specific software code—it being understood that software and control hardware may be designed to the embodiments based on the description herein.

Further, certain portions of the invention may be implemented as logic that performs one or more functions. This logic may include hardware, such as an application specific integrated circuit, a field programmable gate array, a processor, or a microprocessor, or a combination of hardware and software.

No element, act, or instruction used in the description of the present application should be construed as critical or essential to the invention unless explicitly described as such. Also, as used herein, the articles “a” and the term “one of” are intended to include one or more items. Further, the phrase “based on” is intended to mean “based, at least in part, on” unless explicitly stated otherwise.

What is claimed is:

1. A computer-implemented method comprising:
receiving a request to add a video-on-demand (VOD) program, selected by a user from a VOD catalog, to a playlist listing a plurality of programs, wherein at least one of the plurality of programs is associated with the VOD catalog and at least one of the plurality of programs is associated with a program guide of scheduled programs;
adding an indication of the selected VOD program to the playlist; and
displaying the playlist including the indication of the selected VOD program to the user.

2. The computer-implemented method of claim 1, further comprising:
receiving a request to add a scheduled program selected by the user from the program guide to the playlist;
recording the scheduled program and adding an indication of the recorded scheduled program to the playlist; and
displaying the playlist including the indication of the recorded scheduled program and the indication of the selected VOD program to the user.

3. The computer-implemented method of claim 1, further comprising receiving a search query and determining content listed in the program guide or the VOD catalog that matches the search query.

4. The computer-implemented method of claim 3, wherein the content that matches the search query includes the VOD program, the method further comprising presenting to the user an option to add the content that matches the search query to the playlist.

5. The computer-implemented method of claim 4, further comprising sending a notification to the user when the VOD program becomes available or when the VOD program is added to the playlist.

6. The computer-implemented method of claim 4, further comprising periodically searching the VOD catalog or the program guide for content that matches the search query and automatically adding the content that matches the search query to the playlist.

7. The computer-implemented method of claim 1, further comprising
presenting an option to the user to split the playlist into a first playlist listing a plurality of programs associated with the VOD catalog and a second playlist listing a plurality of programs associated with the program guide of scheduled programs; and
receiving an indication from the user of a selection of the option to split the playlist.

8. The computer-implemented method of claim 7, further comprising:
presenting an option to the user to combine the first playlist and the second playlist into a combined playlist; and
receiving an indication from the user of a selection of the option to combine the first playlist and the second playlist.

9. The computer-implemented method of claim 1, further comprising displaying an option to the user to change the order of the plurality of programs in the playlist.

10. A system comprising:
a network device comprising:
a receiver to receive a selection of a video-on-demand (VOD) program to add to a playlist listing a plurality of programs, wherein at least one of the plurality of programs is associated with the VOD catalog and at least one of the plurality of programs is associated with a program guide of scheduled programs;
a processor to add an indication of the selected VOD program to the playlist,
wherein the receiver is configured to receive a request to add a scheduled program from the program guide to the playlist; and
a transmitter to send the playlist for display to a user, the playlist including the indication of the VOD program and the indication of the recorded scheduled program.

11. The system of claim 10, further comprising a memory to store the VOD catalog and a memory to store the program guide, wherein the processor is configured to search the VOD catalog and the program guide for search terms to determine content listed in the program guide or the VOD catalog that matches the search terms.

12. The system of claim 11, further comprising a display, wherein the content that matches the search terms includes the VOD program, and wherein the display presents an option to add the content that matches the search terms to the playlist.

13. The system of claim 12, wherein the transmitter transmits a notification to a user device when the VOD program becomes available and is added to the playlist.

14. The system of claim 12, wherein the processor is further configured to periodically search the VOD catalog or the program guide for content that matches the search query and automatically add the content that matches the search query to the playlist.

15. The system of claim 10, further comprising a display,
wherein the display presents an option to the user to split the playlist into a first playlist listing a plurality of programs associated with the VOD catalog and a second playlist listing a plurality of programs associated with the program guide of scheduled programs; and
wherein the receiver is configured to receive the indication from the user of a selection of the option to split the playlist.

16. The system of claim 15,
wherein the display is further configured to present an option to the user to combine the first playlist and the second playlist into a combined playlist; and
wherein the receiver is configured to receive an indication from the user of a selection of the option to combine the first playlist and the second playlist.

17. The system of claim 1, wherein the receiver is further configured to receive an instruction from the user to change the order of the plurality of programs in the playlist.

18. A device comprising:
a memory to store a playlist listing a plurality of programs, wherein at least one of the plurality of programs is associated with a video-on-demand (VOD) catalog and at least one of the plurality of programs is associated with a program guide of scheduled programs; and
a communication interface to send the playlist to a display for displaying to a user, wherein the communication interface is configured to receive an instruction to add a program selected from the VOD catalog or selected form the program guide to the playlist.

19. The device of claim 18, further comprising the display,
wherein the display is configured to show an option for the user to select to split the playlist into a first playlist listing programs associated with the VOD catalog and a second playlist listing programs associated with the program guide of scheduled programs, and
wherein the communication interface is configured to receive a selection by the user of the option to split the playlist.

20. The device of claim 19,
wherein the display is configured to show an option for the user to select to combine the first playlist and the second playlist, and
wherein the communication interface is configured to receive a selection by the user of the option to combine the first playlist and the second playlist.

21. The device of claim 18, wherein the display show an option to the user to change the order of the plurality of programs in the playlist, and wherein the communication interface is configured to receive a selection by the user of the option to split the playlist.
